(19) United States
(12) Patent Application Publication
(10) Pub. No.: US 2007/0205346 A1
(43) Pub. Date: Sep. 6, 2007

(54) DEVICE FOR SUPPORTING AN ITEM ON A STRUCTURE

(75) Inventors: Trevor Jackson, Kirtland, OH (US); Klaus Harry, Mars, PA (US)

Correspondence Address: CALFEE HALTER & GRISWOLD, LLP, 800 SUPERIOR AVENUE, SUITE 1400, CLEVELAND, OH, 44114, US

(73) Assignee: EMERALD INNOVATIONS LLC, Butler, PA (US)

(21) Appl. No.: 11/671,328

(22) Filed: Feb. 5, 2007

Related U.S. Application Data
(60) Provisional application No. 60/765,058, filed on Feb. 3, 2006.

(51) Int. Cl. F16B 45/00

(52) U.S. Cl. 248/307

(57) ABSTRACT

A device for supporting an item on a structure includes a spanner portion, a first end portion, and a second end portion. The spanner portion includes first and second ends, and a mounting side between the first and second ends for facing a mounting surface of the structure. The first end portion extends laterally from the mounting side at the first end of the spanner portion, and the second end portion extends laterally from the mounting side at the second end of the spanner portion. At least one attachment portion is disposed on at least one of the first end portion and the second end portion and is configured to support at least a portion of the item. The spanner portion is selectively adjustable in length to secure the structure between the first and second end portions of the device.

### CROSS REFERENCE TO RELATED APPLICATIONS

This application claims the benefit of U.S. Provisional Patent Application Serial No. 60/765,058, filed Feb. 3, 2006, entitled ADJUSTABLE HANGER, the entire disclosure of which is hereby incorporated by reference, to the extent that it is not conflicting with the present application.

### BACKGROUND

Hangers and support brackets are often used to support or secure an item, such as, for example, a wreath, garland, or other decorative item, proximate to an upper surface of a structure, such as, for example, a door, mantle, banister, or wall. Many such hangers are generally U-shaped and configured to slip over the top of the structure, with the sides of the U-shaped hanger extending along opposed sides of the structure. Where the width of the structure (distance between opposed sides) differs from the width of the hanger (distance between the sides), proper mounting of the hanger may be impaired. While construction of the hanger in a flexible material, such as plastic, may compensate for minor dimensional differences, the hanger may not fit on substantially wider structures, and may be too loose, and therefore unstable or not secure, on substantially narrower structures.

### SUMMARY

The present application contemplates devices for supporting items, such as, for example, decorative ornaments, on a structure having a mounting surface defined by a first edge and a second edge. According to one inventive aspect of the present application, a device for supporting an item includes a central or spanner portion that is adjustable in length, such that the device is adapted to be secured over structures of varying widths.

Accordingly, in one embodiment, a device for supporting an item on a structure includes a spanner portion, a first end portion, and a second end portion. The spanner portion includes first and second ends, and a mounting side between the first and second ends for facing a mounting surface of the structure. The first end portion extends laterally from the mounting side at the first end of the spanner portion, and the second end portion extends laterally from the mounting side at the second end of the spanner portion. At least one attachment portion is disposed on at least one of the first end portion and the second end portion and is configured to support at least a portion of the item. The spanner portion is selectively adjustable in length to secure the structure between the first and second end portions of the device.

### BRIEF DESCRIPTION OF THE DRAWINGS

Features and advantages of the invention will become apparent from the following detailed description made with reference to the accompanying drawings, wherein:

FIG. 1 is a left side view of an adjustable hanger;

FIG. 2 is an upper rear perspective view of the adjustable hanger of FIG. 1; and

FIG. 3 is an enlarged partial view of the adjustable hanger of FIG. 1.

### DETAILED DESCRIPTION

This Detailed Description merely describes exemplary embodiments according to inventive aspect of the present application and is not intended to limit the scope of the specification in any way. Indeed, the invention as described is broader than and unlimited by the embodiments discussed herein, and the terms used have their full ordinary meaning.

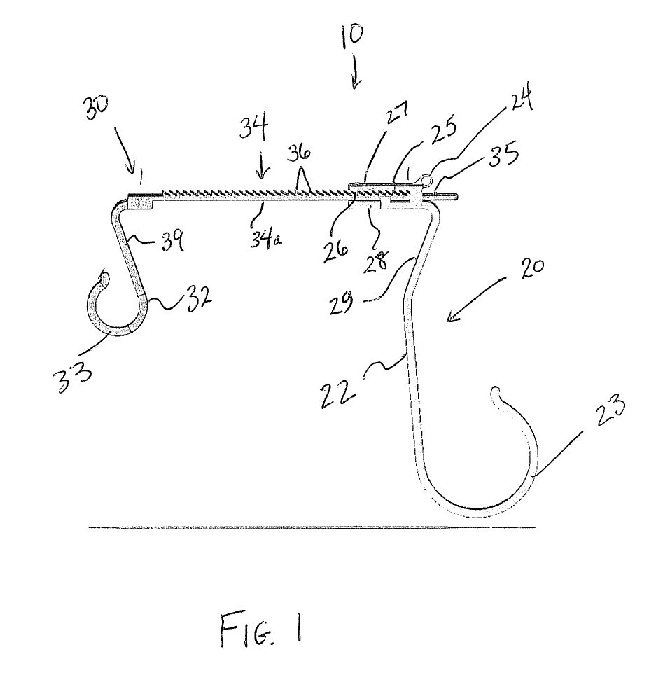

A device may be provided for supporting an item, such as, for example, a wreath, garland, ornament, or other such decorative item, on a structure, such as, for example, a door, wall, mantle, or banister. According to an inventive aspect of the present application, such a device may be provided with a spanner portion that covers or spans a mounting surface of the structure and is adjustable in length, for example, to accommodate structures with mounting surfaces of varying widths, and/or to bring first and second end portions of the device into gripping engagement with the structure. Further, to enhance a grip between the device and the structure, one or both of the first and second end portions may include a resilient inwardly biased portion that grips the structure, for example, when an interference fit is provided between the device and the structure. Many different mechanisms or configurations may be employed to provide a spanner portion of adjustable length for accommodating the mounting surface and for gripping the structure in the device. In one embodiment, a device includes first and second components in sliding engagement with each other to define an adjustable spanner portion. FIGS. 1-3 illustrate one such embodiment of a device 10, in which a first component 20 includes a first end portion 22 of the device 10 and a sleeve or slide member 25 configured to receive a strip therethrough. A second component 30 includes a second end portion 32 and a strip member 35 configured to be inserted through the slide member 25. By positioning the strip member 35 relative to the slide member 25, the length of a spanner portion 34 between the first and second end portions 22, 32 may be adjusted. The spanner portion 34 includes a mounting side 34a oriented to face a mounting surface of a structure (not shown) when the device 10 is assembled with the structure. The mounting side 34a may, but need not, engage the mounting surface when the device is assembled with the structure. In the illustrated embodiment, first and second end portions 22, 32 extend laterally from the mounting side 34a at first and second ends of the spanner portion 34, forming a generally U-shaped device. These portions 22, 32 may extend from the spanner portion 34 substantially perpendicularly or at some other angle, and the portions 22, 32 may be of differing lengths.

While the first and second components 20, 30 may be permitted to loosely slide with respect to each other, for example, to accommodate structures with mounting surfaces of varying sizes, in another embodiment, an engagement mechanism is provided to secure the device in a desired adjusted position, for example, using fasteners, clamps, telescoping arrangements, or engageable detents to secure the first component 20 to the second component 30 in the desired relative position. In one such example, this secured position can provide an interference fit between the device and the structure to which the device is to be mounted. While engageable detents used with the device may take many different forms, including, for example, pin and hole or tab and slot configurations, in one embodiment, engageable detents on the first and second components comprise interlocking teeth that snap into engagement with each other to secure the device in a desired position. To allow for readjustment or removal of the device, one or both of the first and second components may be provided with a flexible portion that allows the engaged teeth (or other detents) to flex out of engagement for further adjustment.

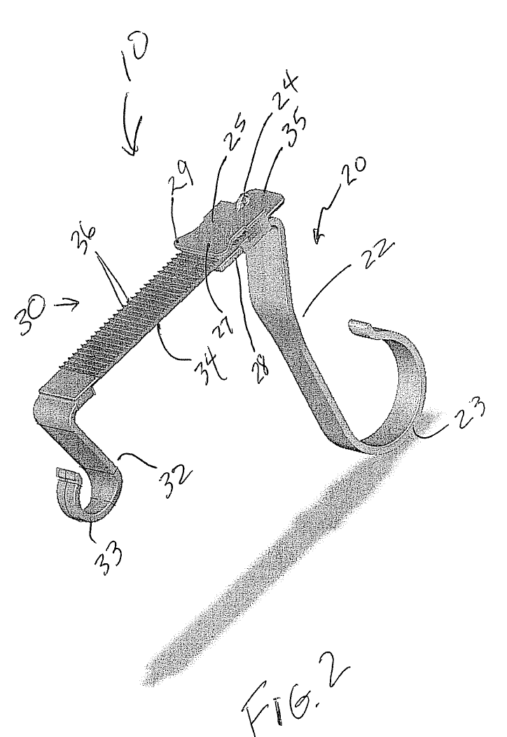

In the illustrated embodiment, the strip member 35 includes a series of detent members or teeth 36 along the length of the strip member 35. The slide member 25 includes detent engaging member or tooth 26 extending from an upper portion or tab 27 of the slide member for engagement with one of the series of teeth 36. Although only one tooth 26 is shown on the exemplary slide member 25, in other embodiments (not shown), multiple detents or teeth may be included, and in one such embodiment (not shown), a single detent member or tooth may be provided on the strip member for engagement with one of a series of teeth on the slide member. To disengage the slide member tooth 26 from the corresponding one of the teeth 36, the tab 27 may be flexed away from strip member 35, thereby allowing the strip member 35 to slide within the slide member 25 for adjustment of the device 10. As more clearly shown in FIG. 2, an outward extending edge 29 may be provided on the tab 27 to facilitate grasping and flexing of the tab 27 by a user. Additionally or alternatively, a base portion 28 of the slide member 25 may be flexible, allowing the strip member 35 to be pressed against the base portion 28 for disengagement of the teeth 26, 36. To provide for resilient flexing of the tab 27 and/or base portion 28, these portions may include a flexible plastic material, such as, for example, a thermoplastic resin, such as polycarbonate.

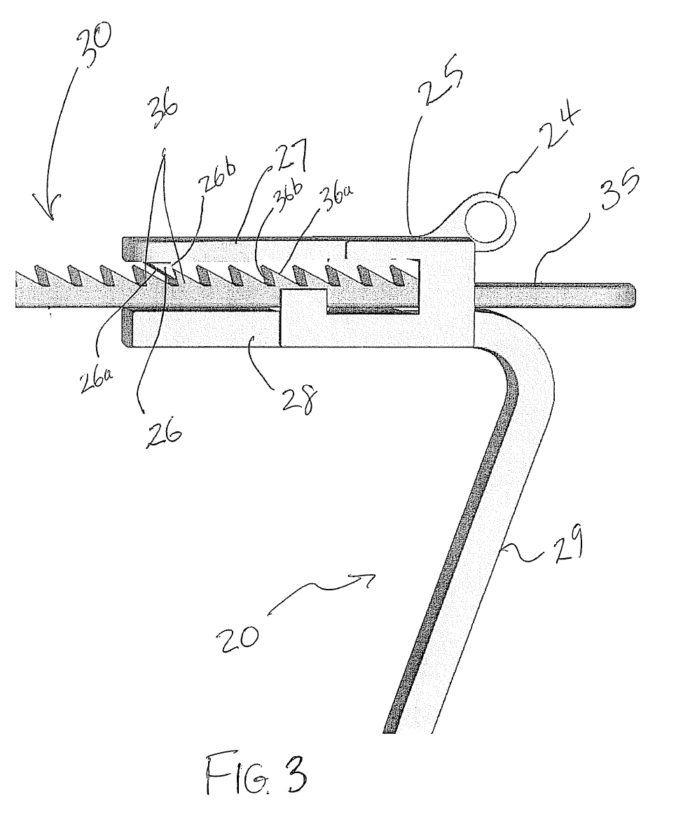

While flexing of the tab 27 may be utilized to disengage the teeth 26, 36 for adjusting the device in both expanding and contracting directions, in one embodiment, the detents or teeth 26, 36 may be configured to allow the device to be contracted (i.e., reducing the length of the spanner portion 34) without flexed disengagement of the tab 27 and/or base portion 28, while requiring such disengagement for expanding the device (i.e., increasing the length of the spanner portion 34). This would allow a user to more easily tighten and maintain the grip of the device 10 on the structure. In the illustrated embodiment, as shown more clearly in FIG. 3, the teeth 26, 36 are angled such that shallow angled camming surfaces 26a, 36a slidingly engage each other to allow movement of the first and second components 20, 30 in a contracting direction, while steeper angled locking surfaces 26b, 36b grippingly engage each other to prevent movement of the first and second components 20, 30 in an expanding direction.

To provide additional grip on the structure, one or both end portions of a device may include a resilient inwardly biased portion that serves to apply a gripping force to the structure when an interference fit is provided between the device and the structure. In the illustrated embodiment, axially inward angled or biased portions 29, 39 are provided on both the first and second end portions 22, 32. When the length of the spanner portion 34 is adjusted to provide an interference fit between the structure and first and second end portions 22, 32 of the device 10, the angled portions 29, 39 are flexed outward (due to engagement with the structure) to accommodate the structure, resulting in inward gripping forces between the first and second end portions and the structure. To provide for resilient flexing of the first and/or second end portions 22, 32, these portions may include a flexible plastic material, such as, for example, a thermoplastic resin, such as polycarbonate.

To attach, secure, hold, or otherwise support an item onto the structure to which the device is to be mounted, at least one of the first and second end portions may include an attachment portion configure to support at least a portion of the item. Examples of such attachment portions include hooks, loops, clips, ties, plugs, sockets, fasteners or other such features. In the illustrated embodiment, both first and second end portions 22, 32 include hooks 23, 33, from which, for example, a wreath or garland may be hung. The exemplary first end portion 22 also includes a loop 24, which may, for example, support a string or wire. It should be noted that in other embodiments of the invention, only one hook (or other attachment portion) may be provided, at either the first or second end portion of the device, or multiple attachment portions may be provided on either first or second end portions.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A device for supporting an item on a structure having a mounting surface extending between opposed first and second surfaces, the device comprising:
a spanner portion having a first end and a second end, and a mounting side between the first and second ends for facing the mounting surface of the structure;
a first end portion extending laterally from the mounting side at the first end of the spanner portion;
a second end portion extending laterally from the mounting side at the second end of the spanner portion; and
at least one attachment portion, disposed on at least one of said first end portion and said second end portion, said at least one attachment portion being configured to support at least a portion of the item;
wherein the spanner portion is selectively adjustable in length to secure the structure between the first and second end portions; and
wherein at least one of said first end portion and said second end portion comprises a resilient portion biased axially inward from the corresponding one of the first and second ends of the spanner portion to grip the structure between the first end portion and the second end portion when the spanner portion is adjusted to provide an interference fit between the structure and the resilient portion.

2. The device of claim 1, further comprising a slide member and a strip member receivable in the slide member for movement of the first end portion with respect to the second end portion for adjusting the length of the spanner portion.

3. The device of claim 2, wherein the strip member includes a series of detent members, and the slide member includes at least one detent engaging member configured to selectively engage one of the series of detent members to secure the first end portion with respect to the second end portion.

4. The device of claim 3, wherein the detent members comprise teeth, and the detent engaging member comprises an interlocking tooth configured to interlock with one of the series of detent members.

5. The device of claim 3, wherein the slide member is configured to hold a portion of the strip member within the slide member in an interference fit engagement with the slide member for engagement of the detent engaging member with one of the series of detent members.

6. The device of claim 3, wherein the detent members and the detent engaging member are configured to prevent movement of the first end portion away from the second end portion and allow movement of the first end portion towards to the second end portion when the detent engaging member is in engagement with one of the detent members.

7. The device of claim 3, wherein at least one of the slide member and the strip member is configured to be flexed to disengage the detent engaging member from the corresponding one of the detent members.

8. The device of claim 3, wherein the detent engaging member is disposed on a flexible tab of the slide member, such that the detent engaging member may be flexed out of engagement with the one of the series of detent member for movement of the first end portion with respect to the second end portion.

9. The device of claim 8, wherein the resilient portion comprises an inwardly angled portion.

10. The device of claim 3, wherein the first end portion and the slide member are disposed on a first component, and the second end portion and the strip member are disposed on a second component.

11. The device of claim 1, wherein the at least one attachment portion comprises a hook.

12. The device of claim 1, wherein both the first end portion and the second end portion comprise resilient portions configured to bias inward from the corresponding ones of the first and second ends of the spanner portion.

13. The device of claim 1, wherein at least one attachment portion is disposed on both the first end portion and the second end portion.

14. A device for supporting an item on a structure having a mounting surface extending between opposed first and a second surfaces, the device comprising:
a spanner portion having a first end and a second end, and a mounting side between the first and second ends for facing the mounting surface of the structure;
a first end portion extending laterally from the mounting side at the first end of the spanner portion;
a second end portion extending laterally from the mounting side at the second end of the spanner portion; and
at least one attachment portion, disposed on at least one of said first end portion and said second end portion, said at least one attachment portion being configured to support at least a portion of the item;
a slide member; and
a strip member receivable in the slide member for movement of the first end portion with respect to the second end portion for adjusting the length of the spanner portion;
wherein one of the slide member and the strip member includes a series of detent members, and the other of the slide member and the strip member includes a detent engaging member configured to selectively engage one of the series of detent members to secure the first end portion with respect to the second end portion.

15. The device of claim 14, wherein the detent members comprise teeth, and the detent engaging member comprises an interlocking tooth configured to interlock with one of the series of detent members.

16. The device of claim 14, wherein the slide member is configured to hold a portion of the strip member within the slide member in an interference fit engagement with the slide member for engagement of the detent engaging member with one of the series of detent members.

17. The device of claim 14, wherein the detent members and the detent engaging member are configured to prevent movement of the first end portion away from the second end portion and allow movement of the first end portion towards to the second end portion when the detent engaging member is in engagement with one of the detent members.

18. The device of claim 14, wherein at least one of the first end portion and the second end portion is configured to be flexed to disengage the detent engaging member from the corresponding one of the detent members.

19. The device of claim 14, wherein the at least one attachment portion comprises a hook.

20. The device of claim 14, wherein the first end portion and the slide member are disposed on a first component, and the second end portion and the strip member are disposed on a second component.
